(19) United States
(12) Patent Application Publication
(10) Pub. No.: US 2019/0364920 A1
(43) Pub. Date: Dec. 5, 2019

(54) Method Of Producing Pierced Cheese

(71) Applicant: Sargento Foods Inc., Plymouth, WI (US)

(72) Inventors: Timothy Hepner, Plymouth, WI (US); Douglas Dreger, Kiel, WI (US); John Brody, Plymouth, WI (US); Ryan Meyer, Elkhart Lake, WI (US)

(21) Appl. No.: 16/399,154

(22) Filed: Apr. 30, 2019

Related U.S. Application Data
(60) Provisional application No. 62/677,941, filed on May 30, 2018.

(51) Int. Cl. A23C 19/14; A23P 30/00

(52) U.S. Cl. CPC A23C 19/14; A23P 30/00; A23V 2300/31; A23C 2250/10; A23V 2002/00; A23C 2250/30

(57) ABSTRACT

A method of producing cheese, more particularly to a method for producing pierced cheese, and more particularly to a method for producing pierced cheese for slicing.

### CROSS REFERENCE TO RELATED APPLICATIONS

This application claims priority to U.S. Provisional Patent Application No. 62/677,941 filed on May 30, 2018, the contents of which are incorporated by reference herein.

### BACKGROUND

During the production process, some cheeses, such as blue vein cheese for example, are pierced to allow oxygen to enter the interior of the block of cheese being produced. Although, blue vein cheeses are the most commonly pierced cheeses, other cheese types can also be so pierced to allow oxygen to enter the interior of the block of cheese such as cheddar, Camembert, and like cheeses known to those in the art. Piercing creates channels through the block that enables the development of mold which imparts flavor and color to the cheese. Piercing is typically done with needles that create the channels in the block. Piercing can be done manually or can be automated with a piercing machine. Channels are created in the block using a needle inserted perpendicularly into the block relative to a plane of the surface of the block that is being pierced. Any of the top, side or bottom surfaces of the block can be utilized for piercing. This perpendicularly pierced cheese is primarily produced as crumbled or block sales units. Slicing conventionally pierced cheese results in cheese slices that are fragile during conversion and use and that have visible needle channels that are not pleasing to the consumer's eye. Thus, there is a need for methods for producing pierced cheese and for producing pierced cheese for slice conversion.

### SUMMARY

In one aspect, disclosed herein is a method for producing cheese. The method includes introducing multiple channels within a block of cheese having therein mold spores by piercing at least one surface of the block at an angle that is other than perpendicular to the at least one surface, incubating the block of under conditions for mold growth, and slicing portions from the block.

In another aspect, disclosed herein is a method for producing a sliceable blue vein cheese. The method includes the steps of introducing multiple channels within a block of vein cheese having therein mold spores by piercing at least one surface of the block at an angle that is between 10 and 80 degrees relative to a first plane of the surface and a second plane perpendicular to the first plane, incubating the block of under conditions for mold growth, and slicing portions from the block.

In another aspect, disclosed herein is a method for producing cheese. The method includes the steps of introducing multiple channels within a block of cheese having therein mold spores by piercing at least one surface of the block at an angle that is other than perpendicular to the at least one surface, incubating the block of under conditions for mold growth, and slicing portions from the block such that such portions have minimized visible elongated channels openings.

### BRIEF DESCRIPTION OF THE DRAWINGS

FIG. 1 is a perspective view of a block of cheese being pierced by a needle at approximately a 45° angle relative to a first plane of the surface of the block being pierced and a second plane perpendicular to the first plane;

FIG. 2 is a perspective view of a block of cheese being pierced by a needle at approximately a 20° angle relative to a first plane of the surface of the block being pierced and a second plane perpendicular to the first plane

FIG. 3 is a schematic of needle piercing angle range Θ with respect to a first plane of the surface of the block being pierced and a second plane perpendicular to the first plane;

FIG. 4 is a side view of the block of FIG. 1;

FIG. 5 is a side view of the block of FIG. 2;

FIG. 6 is a side view of a needle piercing a block of cheese at approximately a 65° angle relative to a first plane of the surface of the block being pierced and a second plane perpendicular to the first plane;

FIG. 7 is a perspective view of a block of cheese being pierced by a piercing machine at approximately a 65° angle relative to a first plane of the surface of the block being pierced and a second plane perpendicular to the first plane;

FIG. 8 is a top view of the block of FIG. 1;

FIG. 9 is a cross sectional view along line 9-9 of FIG. 1;

FIG. 10 is a cross sectional view along line 10-10 of FIG. 2;

FIG. 11 is a cross sectional view of a cheese block;

FIG. 12 is a cross sectional view along line 12-12 of FIG. 2;

FIG. 13 is an exploded view of one slicing orientation;

FIG. 14 is a perspective view of a final slice from the FIG. 13 slicing orientation.

FIG. 15 is a perspective view of a final slice from the block of FIG. 2

FIG. 16 is a perspective view of a final slice from the block of FIG. 6.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The term “blue vein” or “blue vein cheese”, as used interchangeably herein, refers to cheeses produced with milk and ripened with cultures of the mold Penicillium. Any blue vein cheese that is pierced during production to promote the development of mold may be used in accordance with the present invention. Exemplary blue vein cheeses include Blue cheese, Gorgonzola cheese, Stilton cheese, Roquefort cheese, Blue Cheshire cheese, or Buxton blue cheese. Any blue vein cheese that is pierced during production to promote the development of mold may be used. One or more of these blue vein cheeses may be may be defined as such per the Standards of Identity for Dairy Products (see the Code of Federal Regulations, Title 21, Part 131, for example).

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

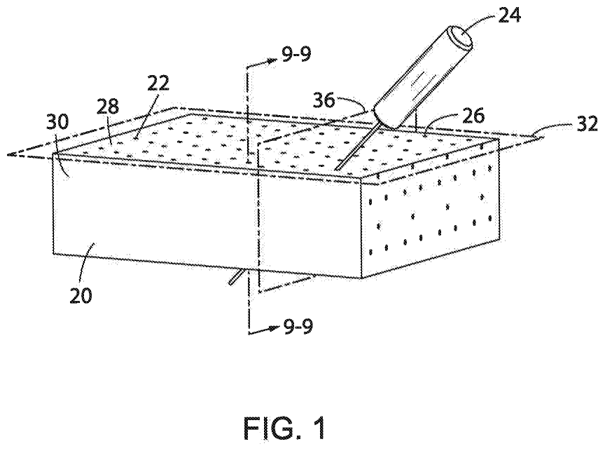

With reference to FIG. 1, a block of cheese 20 is shown. The block 20 can be of any shape and is shown as a rectangle for example. The block includes mold spores therein (not shown). The mold spores may be obtained or produced by any suitable methods known in the art.

For example, a suitable method for producing the block 20 including mold spores for use in the present invention involves providing a milk composition. The milk may be cow's milk, sheep's milk, buffalo's milk, goat's milk, or any other suitable type of milk known within the art for making cheese. The milk composition may be homogenized or non-homogenized. The milk composition may be heated, for example to pasteurize the milk composition or may be unpasteurized. A starter culture is added to the milk composition. The starter culture may be any suitable starter culture or combination of starter cultures for the production of a particular type of cheese to be produced. For example, the starter culture may be one or more mesophilic starter cultures. Mesophilic cultures can be further stratified into lactic acid starter bacteria, which are primarily used for producing lactic acid, and aroma producing bacteria, which are primarily used for producing carbon dioxide and flavor. The starter culture may instill characteristic features to the cheese through various processes, such as, but not limited to, conversion of lactose to lactic-acid and production of other compounds aldehydes and ketones), which enhance cheese flavor and regulate pH. Thereafter, the milk composition is coagulated followed by cutting of the coagulum to provide curd and whey. An enzyme may be added to the milk composition and allowed to set for a suitable time period to allow coagulation of the milk composition prior to cutting. The milk composition may be incubated with the one or more starter cultures and the enzyme under suitable conditions for the appropriate length of time to allow the desired level of coagulation to occur. Such conditions are well known in the art. Following coagulation, the whey and the curd may be separated. The coagulated milk composition may be cut to separate the whey and curd, and the whey may be removed by draining. Salt may then be added to the cheese curds to provide flavor and/or help preserve the cheese. Mold spores are added to the milk composition. The mold spores may be from any suitable mold, such as, for example, Penicillium mold. The mold spores may be added to the milk composition at any suitable time point during the cheese production process. The mold spores may be added to the milk composition before the addition of the one or more starter cultures. The mold spores may be added to the milk composition simultaneously with the addition of the one or more starter cultures. The mold spores may be added to the milk composition after the addition of the one or more starter cultures. For example, the mold spores may be added to the milk composition after coagulation has occurred. The mold spores may be added to the curd before the whey is drained. The mold spores may be added to the curd after the whey is drained. The cheese curds are pressed to form a block. The cheese curds may be pressed using machines that are known within the art to produce the block of any desired shape and size. Alternatively, the cheese curds may be pressed by their own weight to form a block of any desired shape and size.

Referring back to FIG. 1, the block 20 is pierced to create a channel 22 into the interior of the block 20. The piercing can be done with any instrument to create the channel 22 such as a needle 24 shown which is known in the art and which is used to create the multiple channels 22 shown by the piercing holes 26 visible on the surface 28. The needle 24 can be of any desired length, can have a tip that can be flat or concave and can be fabricated from hardened stainless steel, for example. The channels 22 can be created one at a time or multiple channels 22 at one time with the use of multiple needles 24. The channels 22 can be created manually or automated with a suitable machine. The channels 22 can be in a pre-determined pattern or random. Such needles 24 are known to those of skill in the art. The needles 24 can pierce and the channels 22 can be created into any outside surface of the block 20 such as top surface 28, bottom surface (hidden from view in FIG. 1) or a side surface 30. In the depicted embodiments, the block 20 is pierced from a top surface 28 for ease of depiction but any of the outer surfaces can be used as selected by one of skill in the art.

In this embodiment shown in FIG. 1, the channels 22 are created manually and one at a time using a needle 24 that protrudes through the block 20 creating a channel 22 through the entire block 20. However, in other embodiments, one or more channels 22 do not extend through the entire block 20 which will be noted below and in other FIGs. The needle 24 is inserted into the block 20 at an angle 32 that is not perpendicular to the surface 28 of the block 20 to thus create a channel 22 in the block that is not perpendicular to the surface 28 of the block 20. In the embodiment shown in FIG. 1, the needle 24 is inserted into the block 20 and a channel 22 is created in the block 20 that is approximately an angle 32 of 45° from a first plane 34 defined by the surface 28 being pierced and a second plane 36 that is perpendicular to the first plane 32. However, the piercing and channel 22 may be at another angle that is not perpendicular to the plane 34 as will be shown below with respect to other embodiments.

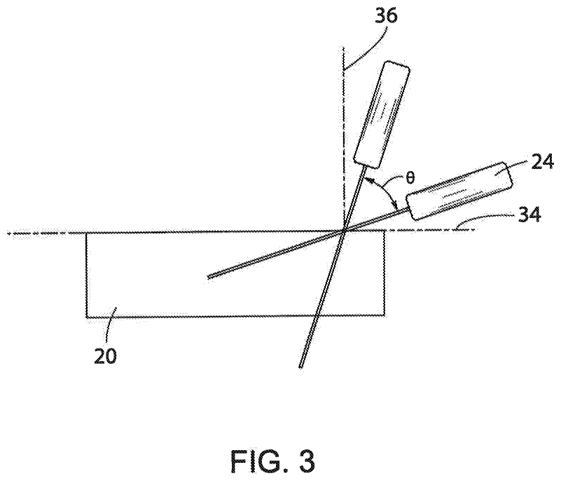

More specifically, and with reference to FIG. 3, the piercing and thus channel angle 32 can be in the range Θ between approximately about 10° to about 80°. For example, the piercing angle may be between about 20° to about 70°, about 30° to about 60°, about 40° to about 50°. For example, the angle may be about 10°, about 30°, about 35°, about 40°, about 45°, about 50°, about 55°, about 60°, about 65°, about 70°, or about 80°. In FIG. 3, Θ is shown for example as 53°.

The multiple channels 22 may be introduced at any suitable pattern chosen by one skilled in the art to achieve the desired level of mold development in the cheese and the desired level of slice integrity. For example, the multiple channels 22 may be introduced at an offset pattern to allow the channels 22 to be farther apart. The distance between the multiple channels 22 may be modified to produce the desired level of mold development and the desired level of slice integrity. The channels 22 can also be aligned in a predetermined pattern as shown in FIG. 1.

The multiple channels 22 are created by piercing the block 20 one or more times. For example, the block 20 may be pierced 2-6 times per square inch. For example, the block 20 may be pierced 2 times per square inch, 3 times per square inch, 4 times per square inch, 5 times per square inch, 6 times per square inch, or any other suitable number desired by one of skill in the art.

The channel 22 may be of any suitable diameter to achieve the desired level of mold in the block 20 as is known in the art. For example, a needle can be utilized to create channels 22 of varying diameters such as, for example, between about ⅛″ and ½″ in diameter or about ⅛″, 3/16″, ¼″, 5/16″, 6/16″, 7/16″, or ½″.

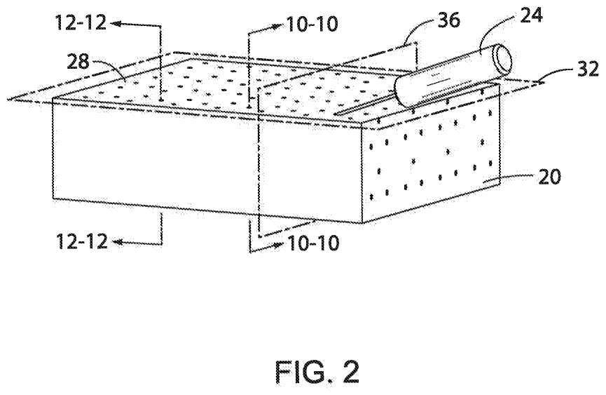

Referring to FIG. 2, a block of cheese 20 is shown with a needle 24 making a channel 22 at approximately an angle 38 of 20° with the needle 24 not extending through the block 20.

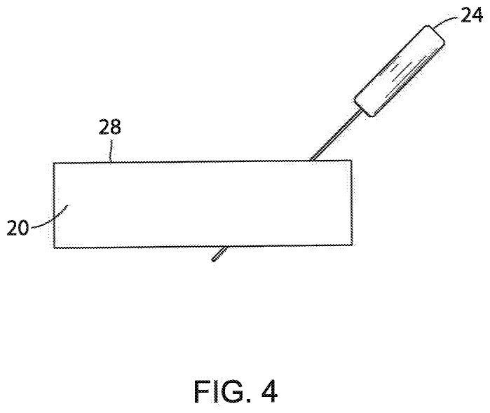

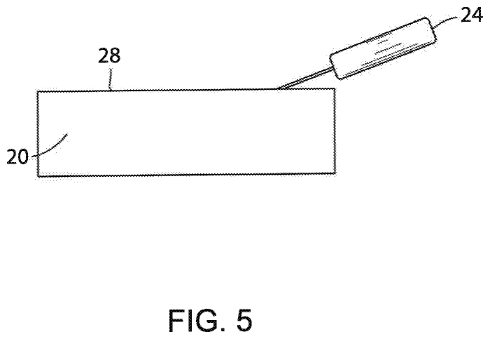

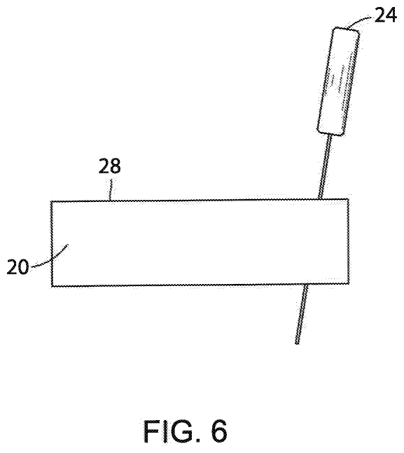

FIGS. 4-6 are examples of side views of a block 20 with a needle 24 making a channel in the block 20 at angles of approximately 45°, 20°, 65°, respectively, with the needle 24 protruding through the block 20 in FIGS. 4 and 6 and not protruding through the block 20 in FIG. 5.

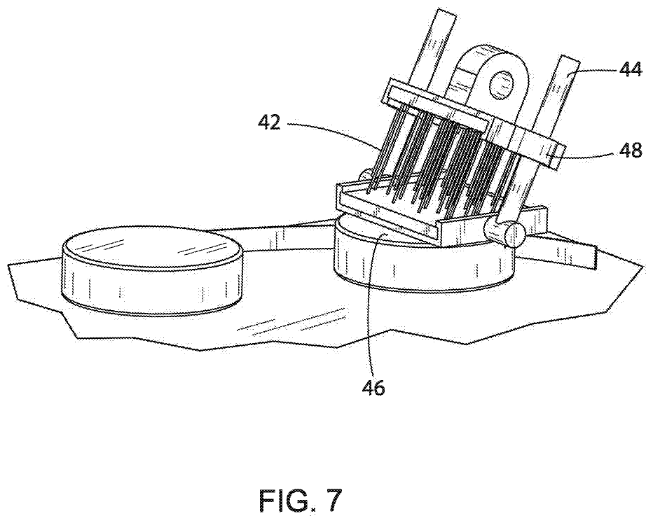

With reference to FIG. 7, a block of cheese 40 is of a circular shape and the multiple channels (not shown) are made simultaneously with multiple needles 42 mounted on a piercing machine 44 in an automated process. The needles 42 are mounted on the machine 44 to be at an angle that is not perpendicular to the piercing surface of the block and is shown at approximately 65° with respect to a first plane of the piercing surface 46 and a second plane perpendicular to the first plane. For example, the one or more needles 42 may be mounted on a carrier 48. The carrier 48 may be mounted at angle as necessary such that the needles 42 will pierce the block 40 at a desired angle relative to the piercing surface 46. The carrier 48 may be moved such that the needles 42 will pierce the block 40 to the desired depth or entirely through the block 40. For example, the carrier 48 may be moved under the action of hydraulic pressure (not shown). Following piercing the block 40 to the desired depth, the needles 42 are retracted from the block 40.

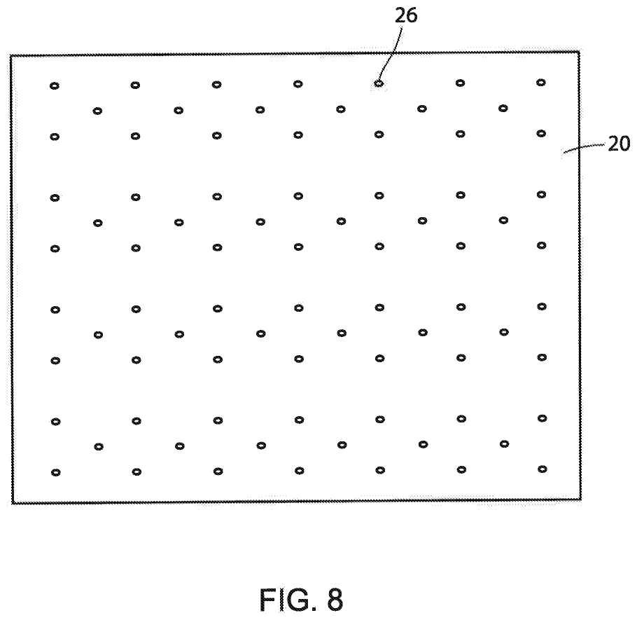

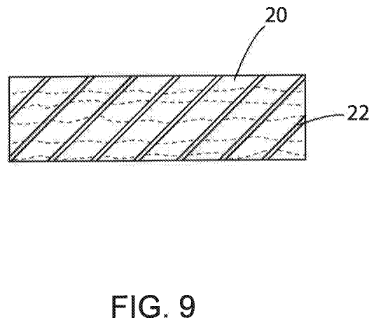

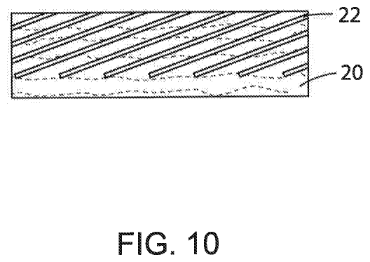

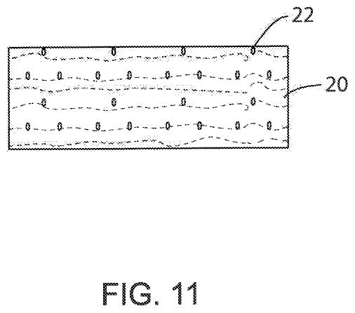

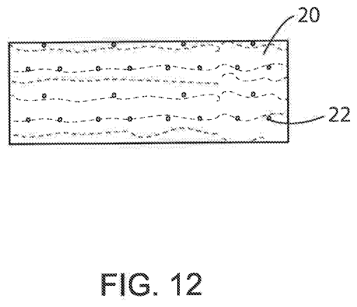

Turning now to FIG. 8, the block 20 of FIG. 1 is shown such that the block 20 is pierced with a given pattern that includes piercing holes 26 that are aligned in a predetermined pattern. In FIGS. 9 and 11, the channels 22 created in the block 20 of FIG. 1 are shown in cross sections. In FIGS. 10 and 12, the channels 22 in the block 20 of FIG. 2 are shown in cross section.

After piercing, the blocks are incubated under suitable conditions for mold to grow within the multiple channels, such incubation being known in the art. Generally, and for example, the incubation method may include aging the block of cheese which includes the mold spores. Aging can instill the appropriate flavor profiles of the resultant cheese. Variables that are important for proper mold development include temperature, humidity, and duration of the aging process. Such variables are well known in the art. For example, the cheese may be aged about 2 weeks to about 1 year, for about 30 days to about 6 months, or for about 30 days to about 90 days. For example, the cheese may be aged for about 14 days, about 30 days, about 45 days, about 60 days, about 75 days, about 90 days, about 120 days, about 150 days, about 200 days, about 250 days, about 300 days, or about 360 days. The cheese may be aged at an appropriate temperature and humidity to ensure adequate growth of the mold. For example, the cheese may be aged at a temperature of about 30° F. to about 75° F. For example, the cheese may be aged at a temperature of about 30° F. to about 75° F., 35° F. to about 70° F., 40° F. to about 65° F., 45° F. to about 55° F., or about 50° F. For example, the cheese may be aged at a temperature of about 40° F., 45° F., 50° F., 55° F., 60° F., or 65° F. The temperature may be consistent for the duration of the aging process. The temperature may be different at various time points during the aging process. The cheese may be aged at a relative humidity of about 75% to about 95%. For example, the cheese may be aged at a relative humidity of about 75%, about 80%, about 85%, about 90%, or about 95%. The humidity may be consistent for the duration of the aging process. The humidity may be different at various time points during the aging process.

After incubating the block of cheese under suitable conditions for mold to grow within the multiple channels, the resultant cheese may be sliced. The cheese may be sliced as necessary to achieve the desired finish slice thickness and size. For example, the cheese block may be sliced directly from the block or cut into subsections, and then sliced to generate the finish slice.

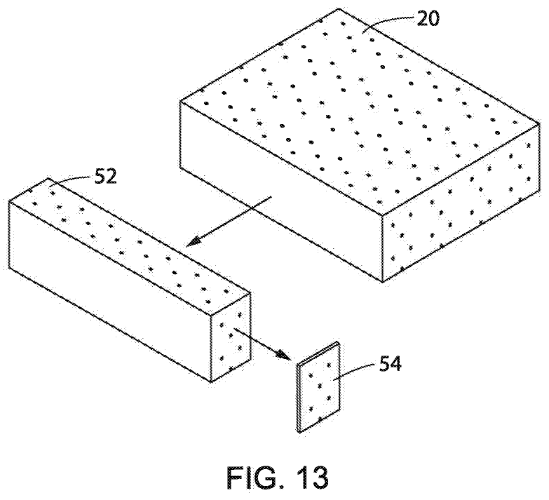

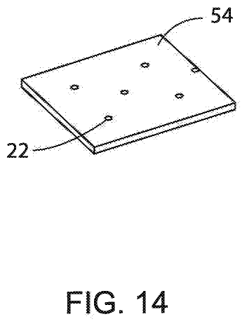

Referring to FIG. 13, one orientation for slicing a block 20 is shown wherein logs 52 are cut from the block 20 by any suitable means then the final slice 54 is cut from log 52 by a suitable means as indicted by the arrows. The block 20, log 52 and/or final slice 54 can be of any dimension such as, for example, the block 20 being 14″×11″×4″, the log 52 being 14″×2.75″×4″ and the final slice 54 being 4″×2.75″ by 0.18″, however, one of skill in the art may cut the final slice 54 of any dimension or directly from the block 20. The final slice 54 is shown in FIG. 14 with portions of channels 22 visible.

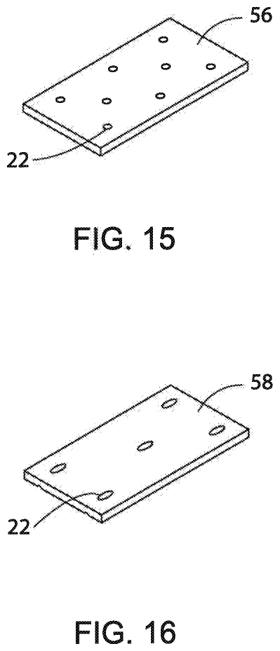

With reference to FIG. 15, an example of a final slice 56 of the block 20 of FIG. 2 is shown with portions of channels 22 visible.

With reference to FIG. 16, an example of a final slice 58 of the block 20 of FIG. 6 is shown with portions of channels 22 visible.

The final cheese slices of the instant invention have enhanced slice integrity, less tearing during slicing and less visible needle marks compared to slices that had been pierced perpendicular to the surface of the block. The final slice of the instant invention shows less or minimal channels from the needle piercing and/or have improved slice integrity due to the orientation of the channels such that the slices are more desirable to consumers. One of skill in the art can adjust the number of channels and/or the channel angle to determine slice integrity.

The present invention is particularly suited for the production and slicing of blue vein cheeses, however, the present invention is also applicable to other cheeses that are pierced to enable mold growth such as cheddars, Camembert and others known to those of skill in the art.

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

What is claimed is:

1. A method for producing cheese comprising the steps:
(a) introducing multiple channels within a block of cheese having therein mold spores by piercing at least one surface of the block at an angle that is other than perpendicular to the at least one surface;
(b) incubating the block of under conditions for mold growth; and
(c) slicing portions from the block.

2. The method of claim 1, wherein the angle is between about 10° to about 80° relative to the plane of the surface and a plane perpendicular to the surface.

3. The method of claim 1, wherein the multiple channels are introduced by piercing the block creating one channel at a time.

4. The method of claim 1, wherein the multiple channels are introduced by piercing the block creating all of the multiple channels at one time.

5. The method of claim 1, wherein the multiple channels are introduced by piercing the block to create 2-6 channels per square inch of the block.

6. The method of claim 1, wherein the channels have a diameter between about ⅛ inch and ½ inch.

7. The method of claim 1, wherein the cheese is Blue cheese, Gorgonzola cheese, Stilton cheese, Roquefort cheese, Blue Cheshire cheese, or Buxton blue cheese.

8. The method of any one of claim 1, wherein the mold spores include at least one of Penicillium mold.

9. The method of claim 1, wherein the angle of each channel is approximately the same.

10. The method of claim 1, wherein the channels are arranged in a predetermined pattern.

11. A method for producing a sliceable blue vein cheese comprising the steps:
(a) introducing multiple channels within a block of blue vein cheese having therein mold spores by piercing at least one surface of the block at an angle that is between 10 and 80 degrees relative to a first plane of the surface and a second plane perpendicular to the first plane;
(b) incubating the block of under conditions for mold growth; and
(c) slicing portions from the block.

12. The method of claim 11, wherein the multiple channels are introduced by piercing the block creating one channel at a time.

13. The method of claim 11, wherein the multiple channels are introduced by piercing the block creating all of the multiple channels at one time.

14. The method of claim 11, wherein the multiple channels are introduced by piercing the block to create 2-6 channels per square inch of the block.

15. The method of claim 11, wherein the channels are introduced by piercing the block manually.

16. The method of claim 11, wherein the channels are introduced by piercing the block in an automated process.

17. A method for producing cheese comprising the steps:
(a) introducing multiple channels within a block of cheese having therein mold spores by piercing at least one surface of the block at an angle that is other than perpendicular to the at least one surface;
(b) incubating the block of under conditions for mold growth; and
(c) slicing portions from the block such that such portions have minimized visible elongated channels potions.

18. The method of claim 17, wherein the multiple channels are introduced by piercing the block creating all of the multiple channels at one time.

19. The method of claim 17, wherein the angle of each channel is approximately the same.

20. The method of claim 17, wherein the channels are arranged in a predetermined pattern.
